(19) United States
(12) Patent Application Publication
(10) Pub. No.: US 2001/0033274 A1
(43) Pub. Date: Oct. 25, 2001

(54) Method and apparatus for erasing previously entered data

(76) Inventor: Joon-Suan Ong, Singapore (SG)

Correspondence Address: HEWLETT-PACKARD COMPANY, Intellectual Property Administration, P.O. Box 272400, Fort Collins, CO, 80527-2400, US

(21) Appl. No.: 09/774,818

(22) Filed: Jan. 30, 2001

Related U.S. Application Data
(63) Continuation-in-part of application No. 08/971,414, filed on Nov. 17, 1997, now abandoned.

(51) Int. Cl. G09G 5/00

(52) U.S. Cl. 345/173

(57) ABSTRACT

A method and apparatus for erasing previously entered data shown at an area on an input device are disclosed. A pen-erase action generates a pressure on the input device and in consequence an electric contact between resistive layers of the input device. By comparing a series resistance including the contact resistance of such electric contact with a predetermined threshold value, the pen-erase action can be detected and the data will then be erased.

This is a continuation-in-part of a application entitled “A METHOD FOR DISTINGUISHING A CONTACT INPUT”, Ser. No. 08/971,414, now abandoned, filed Nov. 17, 1997 by Joon-Suan Ong, and assigned to the present assignee.

### BACKGROUND OF THE INVENTION

The present invention relates generally to input devices. In particular, it relates to a method for erasing previously entered data shown at an area on an input device.

Computational devices which use touch panels as one of their input means are found in abundance in the market place today. A touch panel can either be used independently or in tandem with another input means, such as a keyboard, for data input. In particular, Personal Digital Assistants (PDAs) use transparent resistive digitizer panels, or touch panels, which are overlaid on Liquid Crystal Displays (LCDs) for detecting a pen-tap, or a touch, and for resolving a set of coordinates for the pen-tap location. The resolved coordinate information can then be used to track the pen-tap location on the surface of the digitizer panel. Further uses for the pen-tap coordinates include the implementation of interactive on-screen input and handwriting recognition features in PDAs.

Resistive digitizer panels typically make use of a pair of transparent X-Y substrates with resistive layers which are alternatively energized by a primary voltage to produce a series of secondary voltages upon pen-taps. Each of these secondary voltages is sampled and quantized to provide a controlling processor with a corresponding digital voltage level. The processor subsequently correlates these digital voltage levels to the X-Y coordinates of the pen-tap locations.

To date, most resistive digitizer panels cannot distinguish between pen-tap, or input, and pen-erase, or delete, actions without the use of active electronics in the pen. For example, an advanced digitizer panel working with an active pen can detect the pen tip which is in proximity to the panel surface, in addition to pen-tap and pen-erase actions. Such an active pen, however, must contain elaborate internal electronics requiring a supply cable or a battery for power. This requirement constrains its mobility and ease of handling.

Therefore, there is a need for a simple method to cost-effectively enable a touch panel to perform erase functions without the need for any electronics in the pen.

### SUMMARY OF THE INVENTION

According to one aspect of the invention, the present invention provides a method for erasing previously entered data shown at an area on an input device. The input device has a surface on which a pressure is applied and a pair of underlying resistive layers. The resistive layers are disposed in a known manner which allows the resistive layers to make electrical contact with each other when the pressure is applied. As a consequence, the resistive layers are electrically connected via a contact resistance formed during the electrical contact, thereby forming a resistor network, ideally an H-resistor network, with the divided internal resistance of the resistive layers and the contact resistance.

The method starts by generating a pressure at the area where the data is shown, preferably via a stylus that was also used to enter the data. An electrical contact with a contact resistance between the resistive layers is thus formed in response to the pressure. Consequently, the divided resistor layers provide a pair of series resistors to form the resistor network, together with the electrical contact. A first set of information relating to the resistance of at least one of the series resistors of each resistive layer is collected to determine a location of the electrical contact. Also, an information relating to the contact resistance of the electrical contact is determined. Using the first set of information, a predetermined threshold information is obtained from a set of predetermined location-specific threshold information which relates to the contact resistance of the electrical contact, and is further compared with the information relating to the contact resistance for substantially distinguishing the pressure. If the information relating to the contact resistance is lower than the obtained predetermined threshold information, the previously entered data shown at the area will be erased.

According to another aspect of the invention, a non-electronic eraser for erasing previously entered data shown at an area on a touch panel of a computational device is provided. The touch panel has a similar structure like the above-described input device. The eraser is operatively connected to the panel, and has a relatively large contact area with the touch panel for erasing previously entered data shown on the panel. When a user of the computational device desires to erase previously entered data shown at an area on the panel, the user can generate an area contact at the area on the touch panel by using the eraser to apply a pressure on a surface of the panel. The panel distinguishes such a pressure from a pressure generated by a point contact and identifies the area contact. Subsequently, the previously entered data is erased.

Ideally, the eraser is deformable and blunt. The eraser is also preferred to be elongate.

### BRIEF DESCRIPTION OF THE DRAWINGS

FIG. 1 is a partial exploded view of a prior art resistive digitizer panel;

FIG. 2 is an electrical model of the resistive layers and contact resistance connected together in the resistive digitizer panel of FIG. 1;

FIG. 3 is an illustration of an input device using a preferred embodiment of the present invention to enable the resistive digitizer panel of FIG. 1 to erase previously entered data by applying a pressure which is made by an area contact;

FIG. 4 is a flow chart of the preferred embodiment of the present invention used by the input device of FIG. 3;

FIG. 5 is an electrical model of the resistive layers, the contact resistance and a supply resistor connected together in the input device of FIG. 3;

FIG. 6 is a map of equi-series threshold resistance lines of the resistive digitizer panel used in the input device of FIG. 3;

FIG. 7A illustrates a frond end of a stylus used to enter data; and

FIG. 7B illustrates a back end of a stylus used to erase data entered.

### DETAILED DESCRIPTION OF THE INVENTION

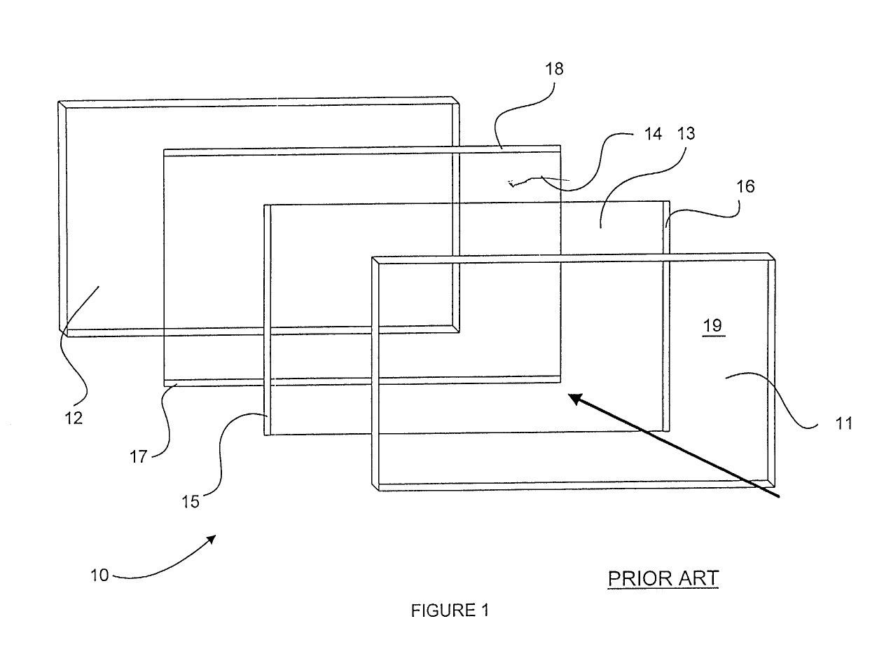

A preferred embodiment of the invention will be described in the ensuing paragraphs as a method for enabling a prior art resistive digitizer panel 10 shown in FIG. 1, to erase previously entered data shown at an area on the input device. The resistive digitizer panel 10, which is preferably transparent, is placed above the display of a PDA 100 for providing a means for input. An arrow representing the viewing direction of the display is also shown in FIG. 1.

The resistive digitizer panel 10 is made of a top substrate 11 staked on resistive layer 14 sandwiched between these substrates. The top substrate 11 has a planar input surface 19 facing the viewing direction, and an opposing surface which faces the display having the X-axis resistive layer 13 formed thereon. Facing this X-axis resistive layer 13 is one of the surfaces of the bottom substrate 12, which is in turn overlaid with the Y-axis resistive layer 14. However, the substrates are disposed in a known manner such that the resistive layers are not normally in electrical contact. In addition, for the resistive digitizer panel 10 to remain transparent and therefore allow light to be transmitted to and from the underlying display, the substrates and the resistive layers are preferred be transparent.

The substrates are electrically insulative while, conversely, the resistive layers are electrically conductive. To allow for connectivity with other electrical elements, therefore, a pair of electrodes are formed on each resistive layer. One end of the X-axis resistive layer 13 is formed with a first electrode 15, while the opposing end in the X-direction is formed with a second electrode 16. Similarly, one end of the Y-axis resistive layer 14 is formed with a third electrode 17, and the opposing end in the Y-direction with a fourth electrode 18.

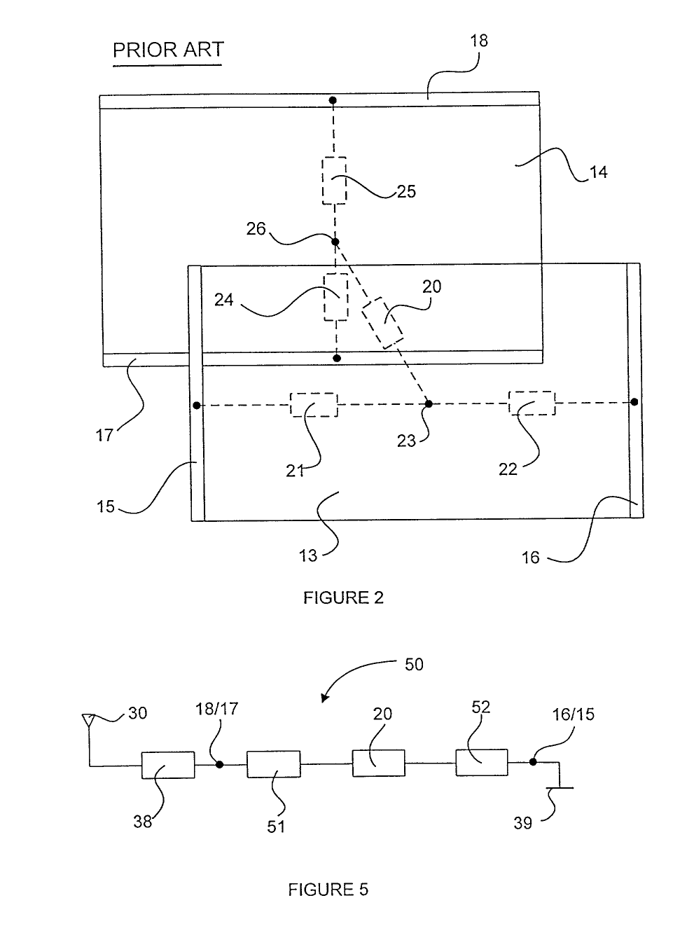

When a pressure is applied to a contact position on the planar input surface 19 of the resistive digitizer panel 10, an electrical contact is established between the resistive layers. A contact resistance 20, illustrated in broken lines in FIG. 2, is thus formed during a transient period when the pressure is applied. As shown in FIG. 2 in further broken lines, the resistive layers are modeled by two pairs of series resistors which are formed from the divided internal resistance of the resistive layers. Each pair of series resistors are connected in series between each pair of electrodes of each resistive layer and are in turn interconnected by the contact resistance 20 during the transient period. An H-resistor network is formed as a result of such an arrangement. For example, the X-axis resistive layer 13 and the corresponding pair of electrodes are modeled by a first series resistor 21 connected to a second series resistor 22 via a first common node 23. The first electrode 15 then forms an open node connected to the first series resistor 21, and the second electrode 16 forms another open node connected to the second series resistor 22. Similarly, the Y-axis resistive layer 14 and the corresponding pair of electrodes are modeled by a third series resistor 24 connected to a fourth series resistor 25 via a second common node 26. The third electrode 17 then forms an open node connected to the third series resistor 24, and the fourth electrode 18 forms another open node connected to the fourth series resistor 25. The contact resistance 20 hence connects to the pairs of series resistors at the common nodes, the positions of which lie generally rectilinear with the contact position along the direction of the applied pressure.

Due to the nonlinear resistive characteristic of the resistive layers, the series resistances of each resistive layer do not behave like the divided resistances of a potentiometer. As is commonly known, a wiper in a potentiometer linearly divides the resistance of a resistive element in the potentiometer according to its position on the resistive element. For the resistive layers, however, the resistance values of the series resistors 21, 22, 24 and 25 are determined by several factors, including the X and Y distances of the contact position from two orthogonal edges of the corresponding resistive layer.

Therefore, in order to determine the location of a pen-tap providing the pressure at the contact position, information relating to the resistance values of the series resistors 21, 22, 24 and 25 according to the contact position are collated prior to the operation of the resistive digitizer panel 10. For example, by applying a DC voltage across the electrodes of one resistive layer and reading the voltage of the corresponding common node, due to simple voltage division of the DC voltage, through any of the open nodes of the other resistive layer, the resistance value of the resistive layer is predetermined and the information stored in a memory. This process is subsequently repeated for the other resistive layer to obtain the corresponding resistance value, and continued for all possible contact positions. This information is then retrieved by a controlling processor (not shown) during operation to compare with subsequently measured voltages to give resolved X-Y coordinate information on the pen-tap location.

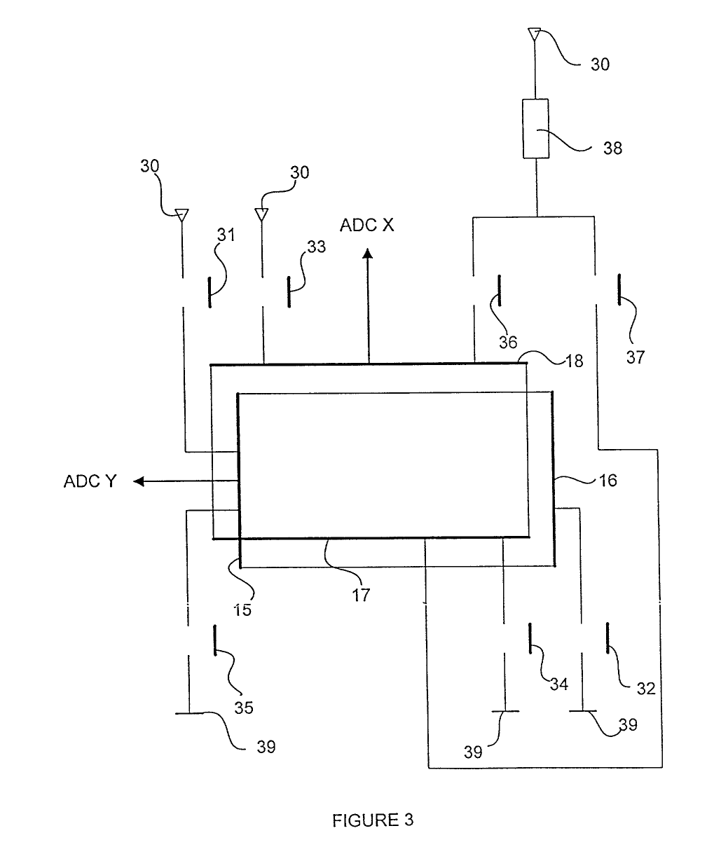

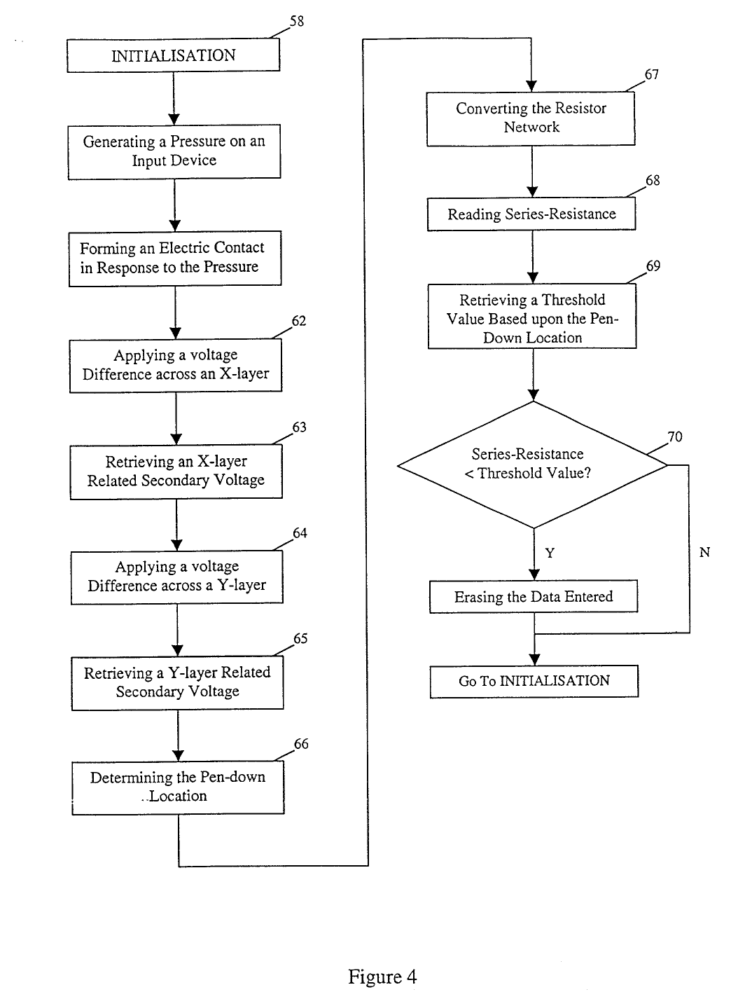

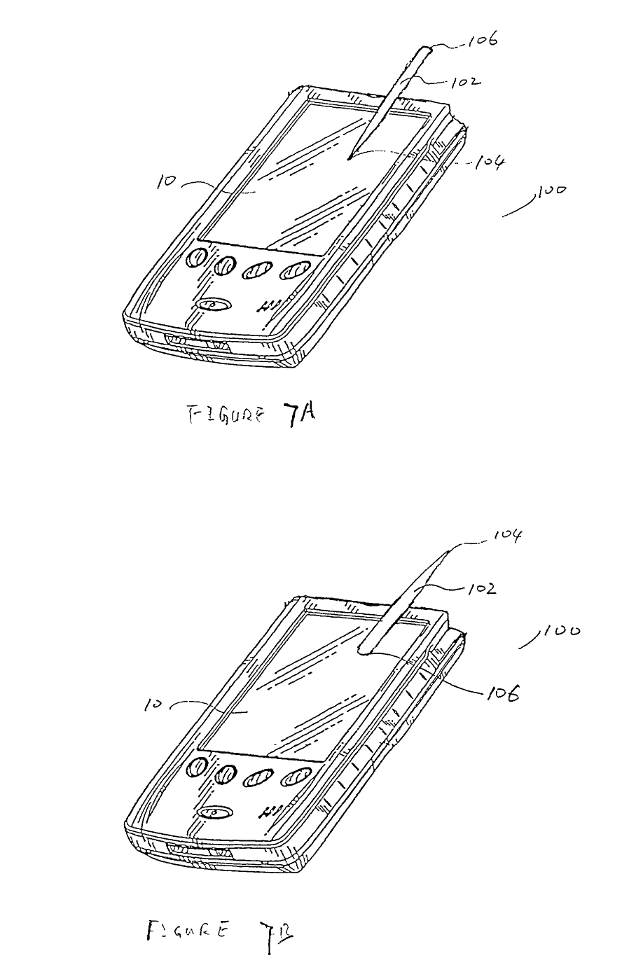

In the preferred embodiment, the user of the PDA 100 can use a front end 104, i.e., the writing end, of the stylus 102 to enter data (FIG. 7A), while use a back end 106, i.e., the eraser end to erase previously entered data shown at an area on the panel (FIG. 7B). The writing end 104 is sharp and hard, just like a regular stylus, for entering data as known in the art. The eraser end 106, however, is relatively deformable and blunt. Preferably, the eraser end 106 has a large contact area with the panel 10. The user can choose to erase previously entered data, such as an item, by flipping the stylus 102 in the user's hand and rubbing the eraser end 106 of the stylus 102 on the item displayed on the panel 10. To achieve this, distinguishing between pen-tap and pen-erase actions is needed. To distinguish between pen-tap and pen-erase actions, however, the behavior of the resistive layers during each type of action must be considered. Firstly, the contact resistance formed between the resistive layers due to a point contact is generally higher than the contact resistance formed due to an area contact, for a constant applied pressure. In addition, the common nodes representing the electrical connections between the resistive layers and the contact resistance due to a point contact lie generally rectilinear with the point of contact along the direction of the applied pressure. On the other hand, the common nodes formed due to an area contact lie generally rectilinear with the center point of the area of contact along the direction of the applied pressure. Since a pen-tap is normally attributed to a point contact, while a pen-erase action, intuitively, involves the use of a soft and wide erasing surface which represents an area contact, it is therefore appropriate to provide a device to distinguish between a point contact and an area contact for identifying a pen-erase action and further to erase the previously entered data. Based on this understanding, an input device is provided in FIG. 3 and is described with reference to FIG. 4 which illustrates the flow chart of distinguishing between pen-tap and pen-erase actions.

As shown in FIG. 4, when the algorithm first begins in an initialization state 58, all switches in the circuit shown in FIG. 3 are reset to their normally-open condition. When the user is to erase previously entered data, such as an item shown on the display, the user rubs the back end of the stylus on the item and thus generates a pressure on the resistive digitizer panel 10 at the area where the item is shown. In response to the pressure, an electrical contact is established between the resistive layers as described above with reference to FIG. 2.

A first pair of switches 31 and 32, shown in FIG. 3 as connecting the first electrode 15 to a voltage (VDD) 30 and the second electrode 16 to a reference (REF) 39 respectively, are then closed as the algorithm enters an X-layer preparation state 62. As a result, a voltage difference (VDD−REF) is applied across the X-axis resistive layer 13 to form a voltage field in the X-direction. The algorithm then performs a short delay for the voltage field to stabilize before proceeding to the next state.

The fourth electrode 18 is shown in FIG. 3 as also being connected to an X-layer analog-to-digital converter (ADC X). Hence when the voltage field stabilizes, the algorithm enters an X-layer read state 63 where a secondary voltage will be formed at the fourth electrode 18 during a pen-down. This secondary voltage will then be converted by the ADC X to a corresponding digital voltage level which is subsequently read by the controlling processor.

The first pair of switches 31 and 32 are reset before the algorithm enters a Y-layer preparation state 64. On entering the Y-layer preparation state 64, a second pair of switches 33 and 34 in FIG. 3 are closed and thus connects the fourth electrode 18 to the voltage (VDD) 30 and the third electrode 17 to the reference (REF) 39 respectively. A delay is again performed for a Y-direction voltage field to settle in the Y-axis resistive layer 14 before the algorithm enters the next state.

The first electrode 15 is shown in FIG. 3 to be connected to a Y-layer analog-to-digital converter (ADC Y). When the algorithm proceeds to a Y-layer read state 65, another secondary voltage produced at the common nodes during the same pen-down action is read at the first electrode 15. This secondary voltage is converted to a corresponding digital voltage level by the ADC Y, which is read by the controlling processor.

The digital voltage levels read during the X-layer read state 63 and the Y-layer read state 65 are subsequently processed by the controlling processor, and compared with a set of predetermined values stored in the memory for resolving the X-Y coordinates of the current pen-down location, and thus the common node position. this process occurs in an X-Y conversion state 66 of the algorithm.

Having determined the X-Y coordinates of the current pen-down location, the algorithm now enters a next state where preparations are made to distinguish between a point contact pen-down and an area contact pen-down. In a series-resistance preparation state 67, a series of switches 32, 35, 36 and 37 in FIG. 3 are closed to effectively short-circuit the first electrode 15 to the second electrode 16, and the third electrode 17 to the fourth electrode 18. By closing these switches, the device can now be modeled by a resistor series circuit 50 illustrated in FIG. 5. The resistor series circuit 50 contains a Y-layer resistor 51, formed from the series resistors 24 and 25 (shown in FIG. 2) connected in parallel, connected in series with the contact resistance 20 and an X-layer resistor 52, formed from the series resistors 21 and 22 (also shown in FIG. 2) connected in parallel. The resistor series circuit 50 is also connected to the voltage (VDD) 30 via a supply resistor 38, and to the reference (REF) 39 via the short-circuited first and second electrodes 15 and 16. The algorithm in FIG. 4 then waits for the voltage difference (VDD−REF) applied across the resistor series circuit 50 to stabilize before entering a next state.

A series-resistance read state 68 shown in FIG. 4 begins once the voltage difference (VDD−REF) stabilizes. In this state, the ADC X connected to the short circuited third and fourth electrodes 17 and 18 reads and converts a further secondary voltage produced thereby, into a corresponding digital voltage level. This digital voltage level is further converted into information on the series resistance of the Y-layer resistor 51, the contact resistance 20 and the Y-layer resistor 52.

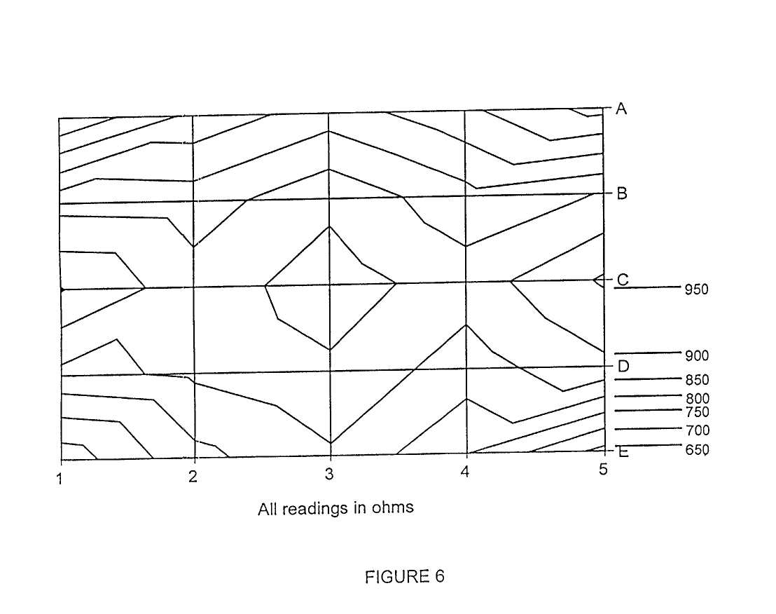

Subsequently, a predetermined threshold resistance value is retrieved in step 69 from a memory, which was stored prior to operation, using the known position of the common nodes. Alternatively, the predetermined threshold resistance value can be retrieved by using the digital voltage levels read in the steps of 63 and 65. The predetermined threshold resistance value represents the series resistance when the pressure is applied through a point contact, and as such, a lower measured series resistance will indicate the presence of an area contact. The predetermined threshold resistance value was prepared prior to operation by way of calibration, and an illustrative map of this value according to all possible common node position on the resistive digitizer panel of FIG. 1 is shown in FIG. 6.

This series resistance read during state 68 is then compared with the predetermined threshold resistance value retrieved as shown in the comparison step 70. If the result of the comparison step 70 is yes, i.e., the series resistance is lower than the predetermined threshold resistance value retrieved from the memory, the controlling processor will identify that the pen-down action is to erase previously entered data. Consequently, previously entered data will be erased. If the result of the comparison step 70 is no, however, the algorithm goes back to the Initialization state.

The preferred embodiment of the present invention described in the preceding paragraphs is not to be construed as limitative. For example, the series of switches 32, 35, 36 and 37 in FIG. 3 need not be closed simultaneously in the series-resistance preparation state 67 in FIG. 4, for the embodiment to effectively distinguish between a point contact and an area contact. The switches 32 and 37 may remain open in this state, and as a result, the series resistance map in FIG. 6 will consequently become more complex. In addition, the predetermined threshold values stored in the memory need not be restricted to series resistance values so long as the device is capable of using the predetermined threshold values to determine the contact resistance.

What is claimed is:

1. A method for erasing previously entered data shown at an area on an input device, comprising:
generating a pressure on said area where the data is shown;
forming an electrical contact with a contact resistance between a pair of resistive layers of the input device in response to the pressure to further form a resistor network, wherein each divided internal resistive layer provides a pair of series resistors to form the resistor network;
collecting a first set of information relating to the resistance of at least one of the series resistors of each resistive layer to determine a location of the electrical contact;
determining an information relating to the contact resistance of the electrical contact;
obtaining a predetermined threshold information from a set of predetermined location-specific threshold information relating to the contact resistance of the electrical contact by using the first set of information;
comparing the information relating to the contact resistance with the predetermined threshold information for distinguishing the pressure; and
erasing said previously entered data if the information relating to the contact resistance is lower than the predetermined threshold information.

2. The method of claim 1, wherein the resistor network is an H-resistor network, and the electrical contact forms a shunt resistor.

3. The method of claim 1, wherein the step of collecting the first set of information includes applying a first voltage across the series resistors of each resistive layer.

4. The method of claim 3, wherein the step of collecting the first set of information further includes collecting a set of information on the voltage differences across at least one of the series resistors of each resistive layer.

5. The method of claim 1, wherein the step of determining information relating to the contact resistance includes applying a second voltage across at least one of the series resistors of each resistive layer, the electrical contact and a resistor of pre-selected resistance, all of which are arranged in a series.

6. The method of claim 5, wherein the step of determining the information relating to the contact resistance further includes measuring the voltage difference across the series resistors and the electrical contact.

7. The method of claim 6, wherein the step of determining the information relating to the contact resistance further includes converting the measured voltage into the series resistance of the series resistors and the electrical contact.

8. The method of claim 5, wherein the step of determining the information relating to the contact resistance further includes connecting the series resistors of each resistive layer in parallel.

9. The method of claim 1, wherein the step of obtaining the predetermined threshold information includes obtaining the predetermined threshold information from a set of predetermined threshold series resistance of at least one of the series resistors of each resistive layer and the electrical contact in response to a pressure generated by a point contact.

10. A computational device comprising:
a display for displaying entered data at an area;
a panel covering the display for data entry and erasure, the panel having a pair of resistive layers; and
a tool, operatively connected to the display, for erasing entered data shown on the display by applying a pressure at the area on the panel to generate an area contact,
wherein the resistive layers form a resistor network in response to the pressure so as to identify the area contact and subsequently erase the entered data shown at the area.

11. The computational device of claim 10, wherein the tool is elongate with a distal end for data entry into the computational device and with a second end for erasing entered data.

12. The computational device of claim 10, wherein the tool is inert and non-electronic and the eraser end is deformable and blunt.
